(19) United States
(12) Patent Application Publication
(10) Pub. No.: US 2011/0114575 A1
(43) Pub. Date: May 19, 2011

(54) RACK ENCLOSURE

(75) Inventors: WEN-TANG PENG, Tu-Cheng (TW); WEI QIU, Shenzhen City (CN); ZHONG-YANG YAN, Shenzhen City (CN)

(73) Assignees: HONG FU JIN PRECISION INDUSTY (ShenZhen) CO. LTD., Shenzhen City (CN); HON HAI PRECISION INDUSTRY CO., LTD., Tu-Cheng (TW)

(21) Appl. No.: 12/854,299

(22) Filed: Aug. 11, 2010

(30) Foreign Application Priority Data
Nov. 16, 2009 (CN) 200910309811.9

(51) Int. Cl. A47B 81/00; F16M 13/02

(52) U.S. Cl. 211/26; 248/205.1

(57) ABSTRACT

An exemplary rack enclosure includes a frame, and two opposite first brackets and two opposite second brackets mounted on the frame in parallel for securing an electronic device thereon. Each of the first brackets includes a mounting plate secured on the frame and parallel and spaced abutting sheets extending from a side of the mounting plate for supporting an end of the electronic device.

### BACKGROUND

1. Technical Field

The disclosure relates to a rack enclosure.

2. Description of Related Art

A typical rack enclosure includes a hollow cuboid frame and four brackets vertically secured on the frame. Electronic devices, particularly servers, are commonly arranged on the brackets and stacked vertically within the typical rack enclosure. The brackets generally meet industry standard of EIA-310-D or other industry standards. In order to secure the electronic devices on the brackets, it needs to have two additional extendable rail assemblies mounted to two opposite sides of the frame, from front to back on each side of the frame for example. That results in the inconvenience of the assembly of the electronic devices.

What is needed, therefore, is a rack enclosure which overcomes the above-mentioned limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, assembled view of a rack enclosure with first brackets in accordance with a first embodiment, wherein the rack enclosure comprises second brackets, and has an electronic device mounted on the first and second brackets.

FIG. 2 is an isometric, exploded view of the first and second brackets, and the electronic device mounted on the rack enclosure of FIG. 1.

FIG. 3 is an isometric view of one of the first brackets of the rack enclosure of FIG. 1.

FIG. 4 is a top plan view of the one of the first brackets of FIG. 3.

FIGS. 5-6 are schematic views of the process of mounting the electronic device on the first and second brackets of the rack enclosure of FIG. 1.

FIG. 7 is an isometric view of one of first brackets in accordance with a second embodiment, wherein the first brackets are used in the rack enclosure of FIG. 1.

FIG. 8 is a top plan view of the one of the first brackets of FIG. 7.

FIG. 9 is an isometric view of one of first brackets in accordance with a third embodiment, wherein the first brackets are used in the rack enclosure of FIG. 1.

FIG. 10 is a top plan view of the one of the first brackets of FIG. 9.

### DETAILED DESCRIPTION

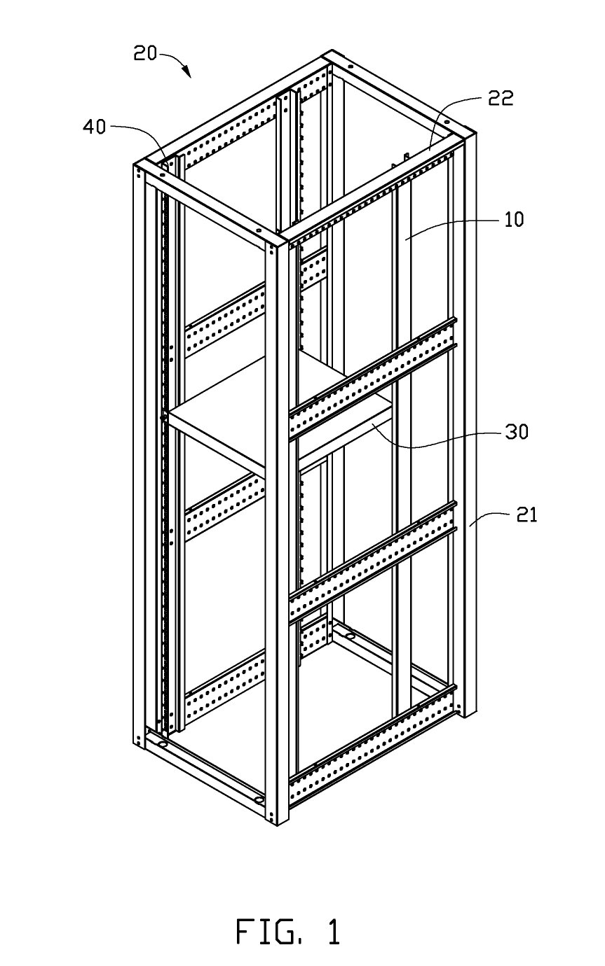

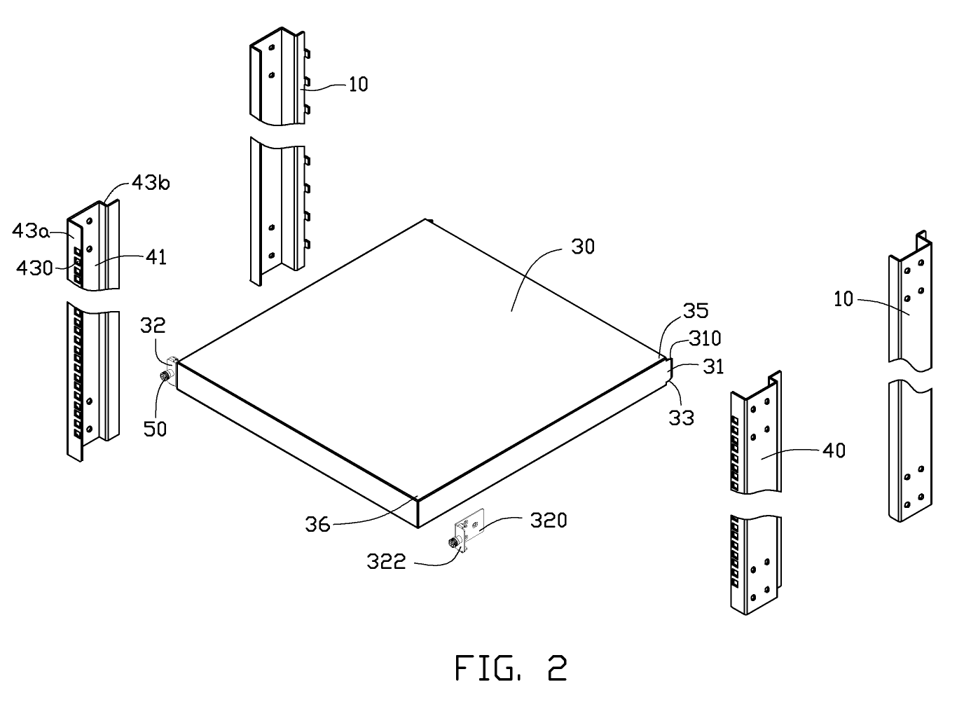

Referring to FIGS. 1-2, a rack enclosure 20 comprises a hollow cuboid frame 21, a pair of first brackets 10 in accordance with a first embodiment, and a pair of second brackets 40. The first brackets 10 are vertically mounted to two opposite sides of the frame 21, and face each other. The second brackets 40 are vertically mounted to the opposite sides of the frame 21, and face each other. The pair of first brackets 10 is separated by a distance from the pair of second brackets 40. An electronic device 30 is mounted on the first and second brackets 10, 40 in this embodiment. In other embodiments, multiple electronic devices 30 can be horizontally arranged on the first and second brackets 10, 40, and stacked within the rack enclosure 20. Each of the second brackets 40 meets industry standard of EIA-310-D. By changing the distance between the pair of first brackets 10 and the pair of second brackets 40, the electronic device 30 with different sizes can be arranged on the first and second brackets 10, 40.

The electronic device 30 comprises two first corners 35 close to the first brackets 10 and two second corners 36 close to the second brackets 40. Each of the first corners 35 defines two cutouts 33 at upper and lower sides thereof. In this embodiment, each first corner 35 has a portion between the cutouts 33 thereof extending outwardly to form a latching sheet 31. The latching sheets 31 of the first corners 35 are coplanar with two opposite sides of the electronic device 30, respectively. Each of the latching sheets 31 is substantially rectangular. Each latching sheet 31 has two third corners from a corresponding first corner 35 cut away to form two guiding surfaces 310. In other embodiments, each first corner 35 may not dispose the latching sheet 31. Two mounting members 32 are secured to the opposite sides of the electronic device 30, close to the second corners 36 of the electronic device 30, respectively. Each of the mounting members 32 comprises a securing sheet 320 secured to a corresponding side of the electronic device 30 and a mounting sheet 322 extending outwardly and perpendicularly from an end of the securing sheet 320. Each of the second brackets 40 comprises a mounting plate 41 and two extending plates 43a, 43b bending inwardly from two opposite sides of the mounting plate 41. The extending plates 43a, 43b extend in the same direction. The extending plate 43a has a width larger than the extending plate 43b. The extending plate 43a with a larger width defines a row of slots 430.

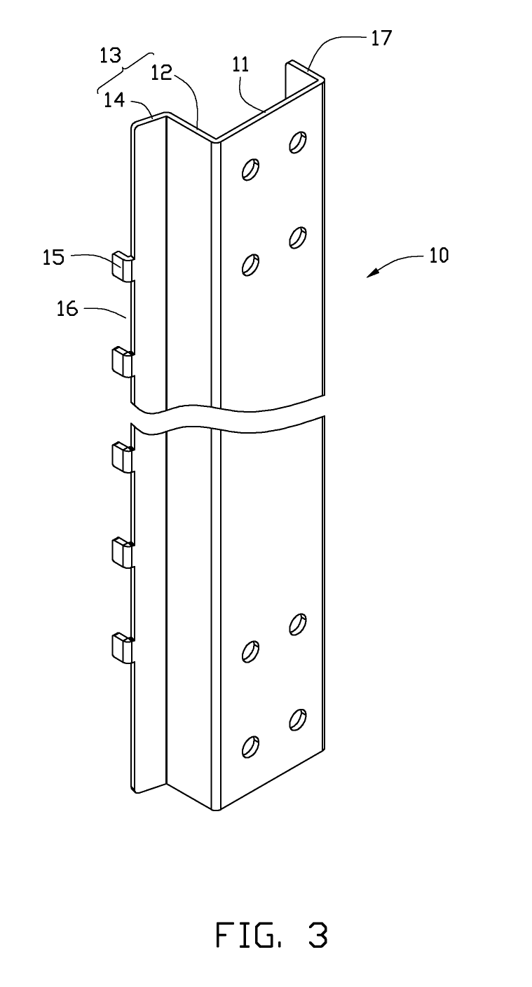

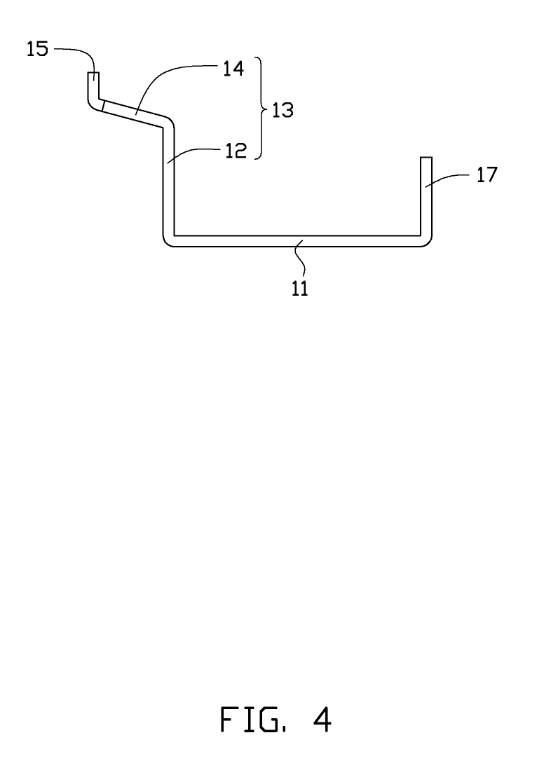

Referring also to FIGS. 3-4, each of the first brackets 10 has an elongated configuration. Each first bracket 10 is integrally formed as a single piece. Each first bracket 10 comprises a rectangular mounting plate 11, a guiding portion 13 bending angularly from an edge of the mounting plate 11, a plurality of separated and parallel abutting sheets 15 extending outwardly from an outer edge of the guiding portion 13, and a bending plate 17 extending from the opposite side of the mounting plate 11. The bending plate 17 is perpendicular to the mounting plate 11. The guiding portion 13 comprises a connecting plate 12 connecting with the mounting plate 11 and a guiding plate 14 bending angularly from the connecting plate 12 along the direction away from the bending plate 17. The connecting plate 12 is parallel to the bending plate 17. The connecting plate 12 and the bending plate 17 extend towards a same direction perpendicular to the mounting plate 11. The connecting plate 12 has a width larger than the bending plate 17. An obtuse angle is defined between the connecting plate 12 and the guiding plate 14, it may be, for instance, approximately 115 degrees. The abutting sheets 15 extend outwardly from the guiding plate 14, and are perpendicular to the mounting plate 11. The abutting sheets 15 extend beyond the guiding portion 13. The abutting sheets 15 are separated by a distance from each other, thereby defining a plurality of receiving spaces 16 therebetween. The distance between two adjacent abutting sheets 15 is designed according to a thickness of the electronic device 30.

In other embodiments, the first brackets 10 may not dispose the bending plate 17. An obtuse angle is defined between the connecting plate 12 and the mounting plate 11.

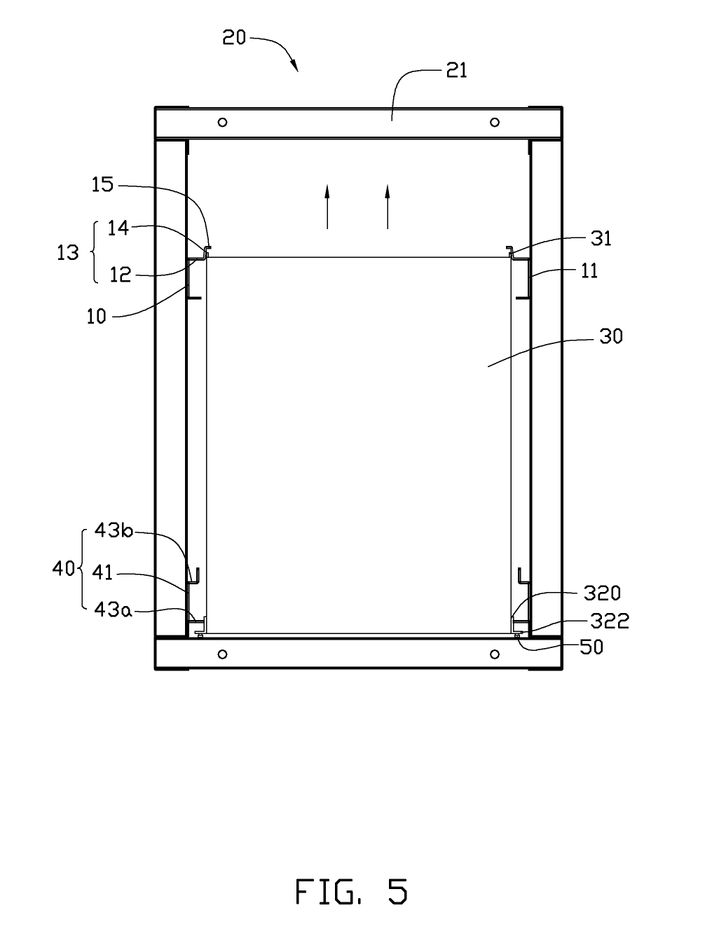

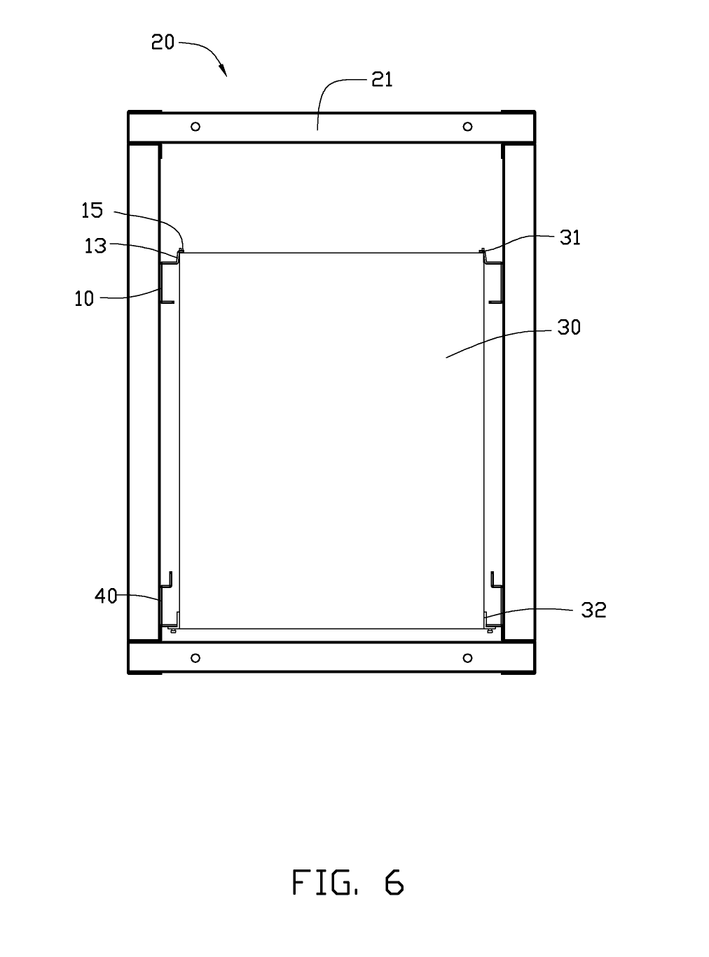

Referring also to FIGS. 5-6, in assembly of the rack enclosure 20, the mounting plates 41 of the second brackets 40 are secured to the two opposite sides of the frame 21, to make the extending plates 43a, 43b extend to an interior of the rack enclosure 20. The mounting plates 11 of the first brackets 10 are secured to the opposite sides of the frame 21, to make the guiding portions 13 and the bending plates 17 extend to the interior of the rack enclosure 20. Each of the latching sheets 31 of the electronic device 30 is guided by the guiding portion 13 and the guiding surface 310 to insert into the receiving space 16 between two adjacent abutting sheets 15. The two adjacent abutting sheets 15 are correspondingly latched in the cutouts 33, thereby clipping the first corners 35 of the electronic device 30 therebetween. Screws 50 (viewed in FIG. 2) extend through each of the mounting sheets 322 of the mounting members 32 and engage into the slots 430 defined in the extending plates 43a with a larger width, whereby the second corners 36 of the electronic device 30 are secured to the second brackets 40. From the above, the electronic device 30 is horizontally secured within the rack enclosure 20. By doing this, multiple electronic devices 30 may be arranged on the first and second brackets 10, 40, and stacked vertically within the rack enclosure 20.

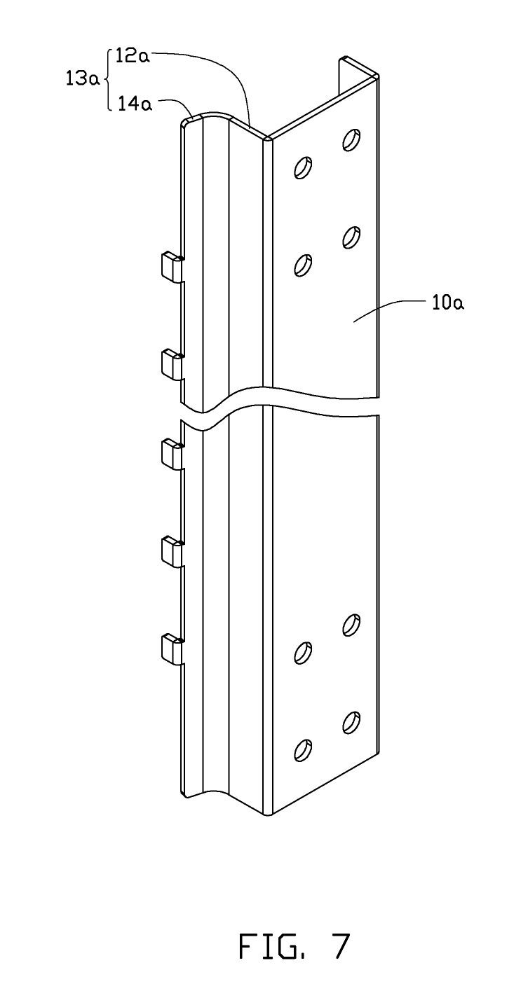

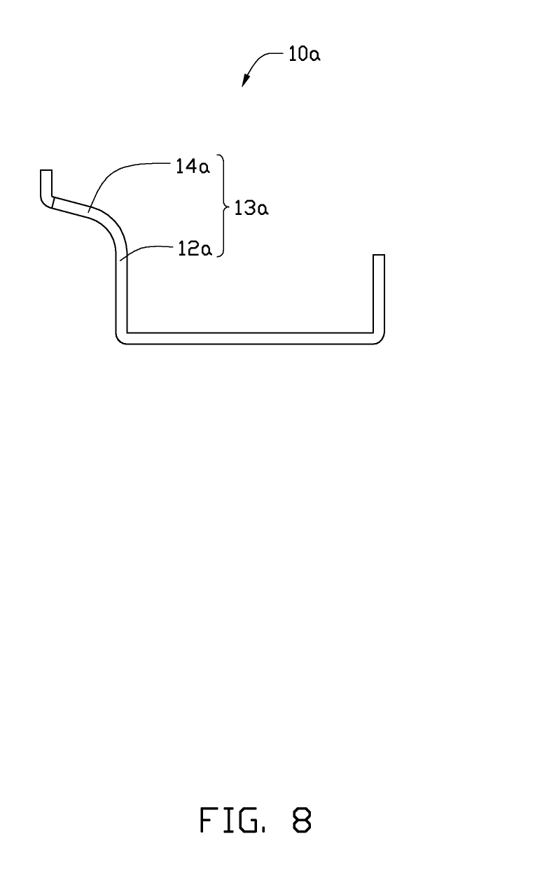

Referring also to FIGS. 7-8, a first bracket 10a in accordance with a second embodiment is used in the rack enclosure 20. The first bracket 10a of the second embodiment is similar to the first bracket 10 of the first embodiment. The main difference is that a connecting portion between the connecting plate 12a and the guiding plate 14a of the guiding portion 13a is connected with a curved portion (not labeled). The connecting portion with the curved portion can guide the latching sheet 31 of the electronic device 30 into the receiving space 16 between two adjacent abutting sheets 15.

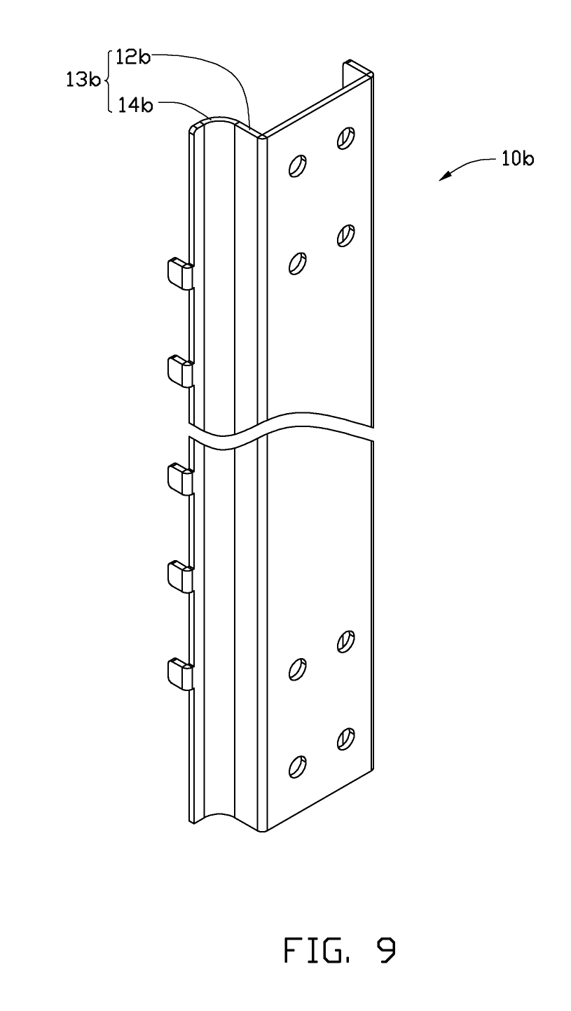

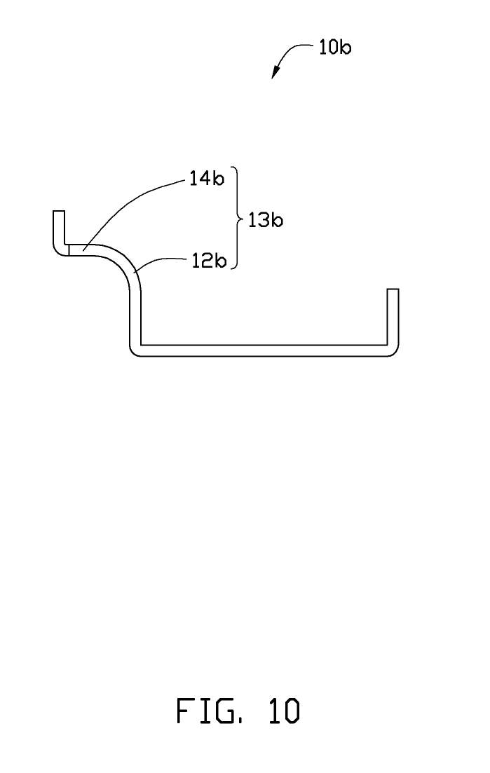

Referring also to FIGS. 9-10, a first bracket 10b in accordance with a third embodiment is used in the rack enclosure 20. The first bracket 10b of the third embodiment is similar to the first bracket 10 of the first embodiment. The main difference is that an angle between the connecting plate 12b and the guiding plate 14b of the guiding portion 13b is a right angle, and a connecting portion between the connecting plate 12b and the guiding plate 14b is connected with a curved portion (not labeled). In this embodiment, the connecting portion between the connecting plate 12b and the guiding plate 14b is a 8 mm fillet. The connecting portion with the curved portion can guide the latching sheet 31 of the electronic device 30 into the receiving space 16 between two adjacent abutting sheets 15.

The first brackets 10, 10a, 10b cooperate with the second brackets 40 meeting industry standard of EIA-310-D to support the electronic device 30, respectively in the first, second and third embodiment. The first corners 35 of the electronic device 30 are supported by corresponding abutting sheets 15 of the first brackets 10, and the second corners 36 of the electronic device 30 are secured on the second brackets 40 by screws 50. There is no need any extendable rail assemblies mounted on the frame 21. Therefore, the assembly of the electronic device 30 is convenient.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A rack enclosure comprising:
a frame;
two opposite first brackets and two opposite second brackets mounted on the frame in parallel, each of the first brackets comprising a mounting plate and a plurality of parallel and spaced abutting sheets extending from a side of the mounting plate; and
a plurality of electronic devices arranged on the first and second brackets and stacked within the rack enclosure, each of the electronic devices comprising two first corners engaging with the first brackets and two second corners engaging with the second brackets;
wherein the first corners of each electronic device abut two corresponding abutting sheets of the first brackets so that the first corners are supported by the corresponding abutting sheets, and the second corners of the electronic device are secured to the second brackets.

2. The rack enclosure of claim 1, wherein the first corners of each electronic device define two cutouts at lower sides thereof, respectively, the corresponding abutting sheets having lower sides thereof latched in the cutouts of the first corners.

3. The rack enclosure of claim 2, wherein the first corners of each electronic device define two cutouts at upper sides thereof, respectively, the corresponding abutting sheets having upper sides thereof latched in the cutouts of the first corners.

4. The rack enclosure of claim 3, wherein each of the first corners has a portion between the two cutouts thereof extending outwardly to form a latching sheet, the latching sheet being located between two adjacent abutting sheets.

5. The rack enclosure of claim 4, wherein each latching sheet has two third corners from a corresponding first corner cut away to form two guiding surfaces, the guiding surfaces guiding the latching sheet into a receiving space defined between two adjacent abutting sheets.

6. The rack enclosure of claim 1, wherein each of the first brackets further comprises a guiding portion bending angularly from the side of the mounting plate along a direction away from an opposite side of the mounting plate, the abutting sheets connecting with an outer lateral edge of the guiding portion, the guiding portion guiding the first corners of each electronic device into a receiving space defined between two adjacent abutting sheets.

7. The rack enclosure of claim 6, wherein the guiding portion comprises a connecting plate connecting with the mounting plate and a guiding plate bending angularly from the connecting plate along the direction away from the opposite side of the mounting plate, an angle defined between the guiding plate and the connecting plate being not smaller than 90 degrees.

8. The rack enclosure of claim 7, wherein the connecting plate is perpendicular to the guiding plate, a connection portion between the connecting plate and the guiding plate of the guiding portion being curved.

9. The rack enclosure of claim 8, wherein the connecting portion between the connecting plate and the guiding plate is a 8 mm fillet.

10. The rack enclosure of claim 7, wherein the angle defined between the connecting plate and the guiding plate is 115 degrees.

11. The rack enclosure of claim 10, wherein a connection portion between the connecting plate and the guiding plate of the guiding portion is curved.

12. The rack enclosure of claim 1, further comprising a plurality of mounting members, wherein each of the mounting members has an end thereof secured to two opposite sides of the electronic device close to the second corners, and has the other end thereof secured to the second brackets.

13. The rack enclosure of claim 1, wherein each of the first brackets is integrally formed as a single piece.

14. A rack enclosure comprising:
a frame; and
two opposite first brackets and two opposite second brackets mounted on the frame in parallel for securing an electronic device thereon, each of the first brackets comprising a mounting plate secured on the frame and a plurality of parallel and spaced abutting sheets extending from a side of the mounting plate for supporting an end of the electronic device,
wherein each of the second brackets defines a row of slots corresponding to the abutting sheets to mount the electronic device.

15. The rack enclosure of claim 14, wherein each of the first brackets further comprises a guiding portion bending angularly from the side of the mounting plate along a direction away an opposite side of the mounting plate for guiding the end of the electronic device, the abutting sheets connecting with an outer lateral edge of the guiding portion.

16. The rack enclosure of claim 15, wherein the guiding portion comprises a connecting plate connecting with the mounting plate and a guiding plate bending angularly from the connecting plate along the direction away the opposite side of the mounting plate, an angle defined between the guiding plate and the connecting plate being not smaller than 90 degrees.

17. The rack enclosure of claim 16, wherein the connecting plate of the guiding portion is perpendicular to the mounting plate, the abutting sheets being perpendicular to the mounting plate.
